(19) United States
(12) Patent Application Publication
(10) Pub. No.: US 2012/0262831 A1
(43) Pub. Date: Oct. 18, 2012

(54) FAULT CURRENT LIMITER

(76) Inventors: Francis Anthony DARMANN, Chatswood (AU); Franco Moriconi, Berkeley, CA (US); Eoin Patrick Hodge, Surry Hills (AU); Albert Nelson, Burlingame, CA (US); Ali Khurram, Cupertino, CA (US)

(21) Appl. No.: 13/085,681

(22) Filed: Apr. 13, 2011

(51) Int. Cl. H02H 9/00

(52) U.S. Cl. 361/93.9

(57) ABSTRACT

A three-phase fault current limiter FCL has three spaced apart input terminals for electrically connecting to respective terminals of a transformer. Three output terminals electrically connect FCL with a load circuit which draws load current I_{LOAD}. FCL includes two longitudinally spaced apart generally circular High Temperature Superconducting (HTS) DC coils which have central generally cylindrical cavities. FCL also includes a longitudinally extending magnetically saturable core which has six like coextensive parallel and elongate posts. Each post includes a first longitudinal portion and, a second longitudinal portion and a third longitudinal portion extending longitudinally oppositely away from the first portion. Each second portion and third portion is received within one of the central cavities. Three copper-based insulated AC coils are each wound about respective first portions for carrying load current I_{LOAD} between input terminals to respective output terminals. DC coils magnetically bias the core such that, in response to one or more characteristics of the load current I_{LOAD}, the AC coils move from a low impedance state to a high impedance state.

### FIELD OF THE INVENTION

The present invention relates to a fault current limiter (FCL).

The invention has been developed primarily for a compact high voltage fault current limiter and will be described with reference to that application. However, the invention is not limited to that particular field of use and is also suitable for low voltage, medium voltage, extra-high voltage and ultra-high voltage fault current limiters.

### BACKGROUND

Any discussion of the prior art throughout the specification should in no way be considered as an admission that such prior art is widely known or forms part of common general knowledge in the field.

There is an increasingly growing importance to ensure the stability of the electrical supply both on the small and large scale. One device of importance in ensuring such supply is a fault current limiter. Recently, magnetically saturated fault current limiters employing high permeability cores have been introduced to the market. Often these devices utilise a DC coil, superconducting or otherwise, for the magnetic saturation of a magnetic material. Upon the occurrence of a fault, the magnetically saturated material is often taken out of saturation to provide higher impedance to the fault current. Example fault current limiters relying upon magnetic saturation can be found in U.S. Pat. No. 7,193,825 to Darmann et al. and U.S. Pat. No. 7,551,410 to Darmann.

Open core fault current limiters are known, for example, from PCT Publication WO 2009/121143 to Darmann. While these fault current limiters offer efficacious functionality, it has been found that their application, in some instances, has been precluded from installations primarily due to packaging requirements. This is particularly relevant for existing electrical sub-stations in which there is a desire to retrofit a fault current limiter in a predetermined and confined space.

### SUMMARY OF THE INVENTION

It is an object of the present invention to overcome or ameliorate at least one of the disadvantages of the prior art, or to provide a useful alternative.

According to a first aspect of the invention there is provided a fault current limiter including:

an input terminal for electrically connecting to a power source that provides a load current;

an output terminal for electrically connecting with a load circuit that draws the load current;

a magnetically saturable core having a longitudinally extending first portion and a second portion that extends longitudinally beyond the first portion;

an AC coil wound about the first portion for carrying the load current between the input terminal and the output terminal; and

a magnetically biasing system located closely adjacent to the second portion for magnetically biasing the core such that, in response to one or more characteristics of the load current, the AC coil moves from a low impedance state to a high impedance state.

In an embodiment, the AC coils require a predetermined physical clearance to an electrical earth and the magnetically biasing system is spaced apart from the core by less than the predetermined clearance.

In an embodiment, the magnetically biasing system includes at least one DC coil wound about and closely adjacent to the second portion.

In an embodiment, the DC coil has a notional inner surface with a first predetermined footprint and the AC coils have a notional outer surface with a second predetermined footprint that extends beyond the first footprint.

In an embodiment, the core is substantially non-uniform in cross-section.

In an embodiment, the core includes a third portion that extends longitudinally beyond the first portion.

In an embodiment, at least one DC coil is wound about and closely adjacent to the third portion.

In an embodiment, the core and the AC coil are housed within an enclosure and the at least one DC coil is outside the enclosure.

In an embodiment, the at least one DC coil is housed in a chamber.

In an embodiment, the enclosure and the DC coil include respective enclosure and DC coil footprints in a transverse plane and the DC coil footprint is no more than the enclosure footprint.

In an embodiment, the enclosure and the DC coil include respective enclosure and DC coil footprints in a transverse plane and the DC coil footprint is substantially the same as the enclosure footprint.

In an embodiment, the core, the AC coil and the at least one DC coil are housed within an enclosure.

In an embodiment, the core includes an array of longitudinally substantially coextensive posts and a plurality of AC coils respectively wound about one or more of the posts in the array, and wherein the posts in the array each have a first end and a second end and the posts are arranged such that the first ends collectively define the second portion and the second ends collectively define the third portion.

In an embodiment, the posts are substantially non-uniform in cross-section.

In an embodiment, the core is constructed from one or more of: a transformer steel lamination material; mild steel; other magnetic steel; ferrite material; an insulated high permeability compressed powder; and a ferromagnetic material.

In an embodiment, the enclosure includes a dielectric medium.

According to a second aspect of the invention there is provided a fault current limiter including:

at least three input terminals for electrically connecting to a three phase power source that provides a load current;

at least three output terminals for electrically connecting with a three phase load circuit that draws the load current;

a magnetically biasing system having a central cavity;

a longitudinally extending magnetically saturable core having a plurality of posts, wherein:

each post includes a first portion and a second portion and a third portion extending longitudinally oppositely away from the first portion; and

the second portion is received within the central cavity;

at least three AC coils each being wound about at least one of the first portions for carrying the load current between the input terminals and the output terminals, wherein the biasing system magnetically biases the core such that, in response to one or more characteristics of the load current, the AC coils move from a low impedance state to a high impedance state.

According to a third aspect of the invention there is provided a fault current limiter including:

an input terminal for electrically connecting to a power source that provides a load current;

an output terminal for electrically connecting with a load circuit that draws the load current;

an AC coil wound about a longitudinally extending first portion of a magnetically saturable core for carrying the load current between the input terminal and the output terminal, wherein the core and the AC coil are housed within an enclosure; and

a magnetically biasing system located adjacent the core for magnetically biasing the core such that, in response to one or more characteristics of the load current, the AC coil moves from a low impedance state to a high impedance state, and wherein the enclosure and the biasing system include respective enclosure and biasing system footprints in a transverse plane and the biasing system footprint is no more than the enclosure footprint.

In an embodiment, the magnetically biasing system includes at least one DC coil wound about the core.

In an embodiment, the core includes a second portion which extends longitudinally beyond the first portion and the DC coil is wound about the second portion.

In an embodiment, the core includes a third portion that extends longitudinally beyond the first portion.

In an embodiment, at least one DC coil is wound about the third portion.

In an embodiment, the enclosure and DC coil footprints are substantially coextensive.

In an embodiment, the DC coil footprint lies within the enclosure footprint.

According to a fourth aspect of the invention there is provided an enclosure for a fault current limiter, the enclosure including:

a first port for receiving an input terminal for electrically connecting to a power source that provides a load current;

a second port an output terminal for electrically connecting with a load circuit that draws the load current;

a first zone for receiving a first portion of a magnetically saturable core, the first zone having a predetermined first transverse footprint;

a second zone that extends longitudinally beyond the first zone for receiving a second portion of the core, the second zone having a predetermined second transverse footprint that is no more than the first footprint;

an AC coil wound about the first portion for carrying the load current between the input terminal and the output terminal; and

a magnetically biasing system located adjacent the second portion for magnetically biasing the core such that, in response to one or more characteristics of the load current, the AC coil moves from a low impedance state to a high impedance state.

In an embodiment, the magnetically biasing system includes at least one DC coil wound about the second portion.

### BRIEF DESCRIPTION OF THE DRAWINGS

Embodiments of the invention will now be described, by way of example only, with reference to the accompanying drawings in which:

FIG. 1 is a schematic view of a three phase fault current limiter (FCL) according to an embodiment of the invention disposed in an electrical distribution system (EDS);

FIG. 2 is a partially cutaway perspective view of the FCL of FIG. 1;

FIG. 3 is a top view of the FCL of FIG. 1 in which the pairs of posts within a phase are located adjacent to one another;

FIG. 4 is a top view of a FCL in which the pairs of posts within a phase are located opposite to one another;

FIG. 5 is a cut away side view of a single phase FCL;

FIG. 6 is a partially cutaway perspective view of the FCL of FIG. 5;

FIG. 7 is a cut away perspective view of a three phase FCL;

FIG. 8 is a cut away side view of a single phase FCL having a core that is substantially non-uniform in cross-section;

FIG. 9 is a cut away perspective view of a three phase FCL having a core that is substantially non-uniform in cross-section;

FIG. 10 is a cut away side view of a single phase FCL having a core that is substantially non-uniform in cross-section;

FIG. 11 is a cut away perspective view of a three phase FCL having a core that is substantially non-uniform in cross-section;

FIG. 12 is a cut away side view of a single phase FCL similar to FIG. 5 but in which the DC coils are housed within the tank;

FIG. 13 is a cut away perspective view of a three phase FCL similar to FIG. 7 but in which the DC coils are housed within the tank;

FIG. 14 is a cut away side view of a single phase FCL similar to FIG. 8 but in which the DC coils are housed within the tank;

FIG. 15 is a cut away perspective view of a three phase FCL similar to FIG. 9 but in which the DC coils are housed within the tank;

FIG. 16 is a cut away side view of a single phase FCL similar to FIG. 10 but in which the DC coils are housed within the tank;

FIG. 17 is a cut away perspective view of a three phase FCL similar to FIG. 11 but in which the DC coils are housed within the tank;

FIG. 18 is a cut away side view of a single phase FCL having a single DC coil housed within the tank;

FIG. 19 is a cut away side view of a single phase FCL having a core that is substantially non-uniform in cross-section and a single DC coil housed within the tank;

FIG. 20A is a block diagram of a first single phase FCL;

FIG. 20B is a block diagram of a second single phase FCL;

FIG. 20C is a block diagram of a third single phase FCL having a core that is substantially non-uniform in cross-section;

FIG. 21 is a schematic of a test circuit employed to test the FCLs under various DC bias conditions;

FIG. 22 is a graph illustrating the DC bias characteristic of the FCLs of FIGS. 20A, 20 B and 20C;

FIG. 23 is a graph illustrating the measured fault current waveforms at a set of DC bias values;

FIG. 24 is a graph similar to FIG. 23 but with a larger time interval scale; and

FIG. 25 is a graph illustrating the induced current into the DC bias circuit during the fault of FCLs of FIGS. 20A, 20 B and 20C at a set of DC bias values.

### DETAILED DESCRIPTION

The following description and Figures make use of reference numerals to assist the addressee understand the structure and function of the illustrated embodiments. Like reference numerals are used in different embodiments to designate features having the same or similar function and/or structure.

The drawings need to be viewed as a whole and together with the associated text in this specification. In particular, some of the drawings selectively omit features to provide greater clarity about the specific features being described. While this is done to assist the reader, it should not be taken that those features are not disclosed or are not required for the operation of the relevant embodiment.

Where use is made of the term “an embodiment” in relation to a feature, that is not to be taken as indicating there is only one embodiment in which that feature is able to be used, or that that feature is not able to be used in combination with other features not illustrated as being in the same embodiment. It will be appreciated by the skilled addressee that while some features are mutually exclusive within a single embodiment, others are able to be combined.

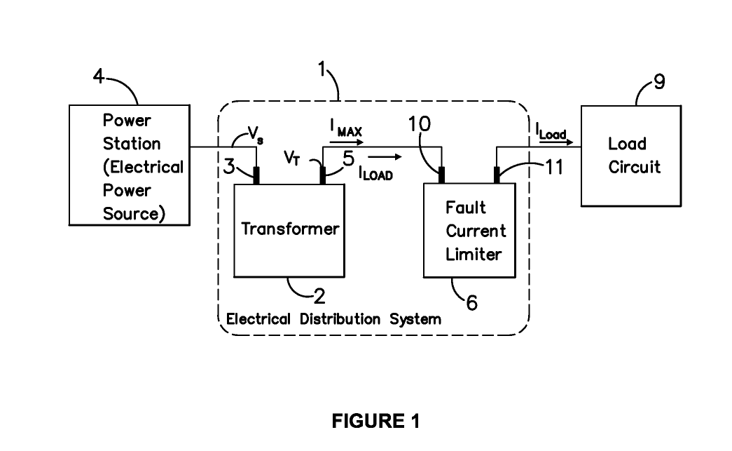

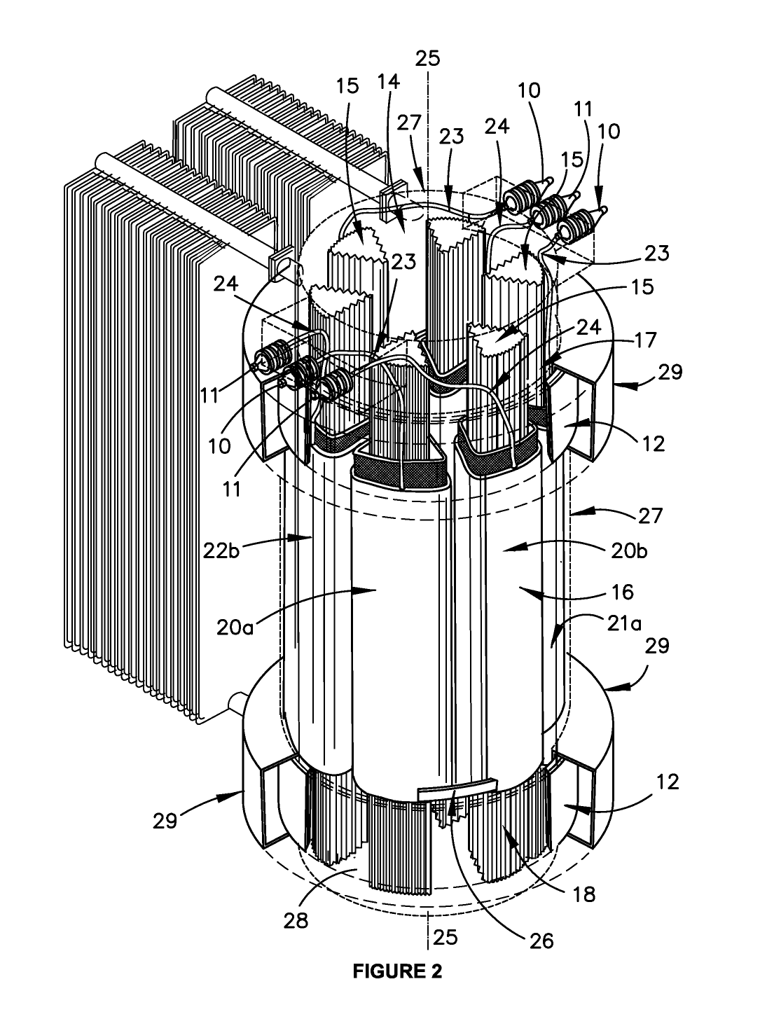

Referring to FIG. 1, there is illustrated an electrical distribution system 1 including a three phase transformer 2 for providing a predetermined maximum operating current I_{MAX} at a predetermined operating voltage V_{T}. Transformer 2 includes three first input terminals 3 (only one shown) for connecting with a three phase electrical power source in the form of a power station 4. The power station provides an operating voltage V_{S}. The transformer also includes three first output terminals 5 (only one shown) that provide a load current I_{LOAD} at the predetermined operating voltage V_{T}. System 1 includes a three phase fault current limiter in the form of FCL 6 that has, as best shown in FIG. 2, three spaced apart second input terminals 10 for electrically connecting to respective terminals 5 of transformer 2. Referring again to FIG. 1, three second output terminals 11 (only one shown) electrically connect FCL 6 with a load circuit 9, which draws load current I_{LOAD}.

The voltage V_{S} in this embodiment is 33 kV. However, in other embodiments alternative voltages are used. Examples of commonly used voltages include 132 kV, 66 kV, 33 kV and many other voltages that will be known to those skilled in the art.

As best shown in FIG. 2, FCL 6 includes a magnetically biasing system having two longitudinally spaced apart generally circular High Temperature Superconducting (HTS) DC coils 12 having central generally cylindrical cavities. FCL 6 also includes a longitudinally extending magnetically saturable core 14 having six like coextensive parallel and elongate posts 15. Each post 15 includes a first longitudinal portion 16, a second longitudinal portion 17 extending away from portion 16, and a third longitudinal portion 18 extending away from portion 16 in the opposite longitudinal direction to portion 17. Each portion 17 and portion 18 is received within one of the central cavities.

Three copper-based insulated AC coils 20, 21 and 22 are each wound about respective first portions 16 for carrying load current I_{LOAD} between terminals 10 to respective terminals 11. DC coils 12 magnetically biases core 14 such that, in response to one or more characteristics of load current I_{LOAD}, AC coils 20, 21 and 22 move from a low impedance state to a high impedance state.

Each AC coil 20, 21 and 22 has two coil segments that are wound in opposite senses about respective first portions 16. For example, coil 20 has two coil segments 20a and 20b. Coil segment 20a is electrically connected to terminal 10 via high voltage, high current insulated conductor 23. Similarly, coil segment 20b is electrically connected to terminal 11 via high voltage, high current insulated conductor 24. The respective coil segments of coils 21 and 22 are similarly connected to terminals 10 and 11 via respective high voltage, high current insulated conductors 23 and 24.

It will be appreciated that in other embodiments, the magnetically biasing system includes other than DC coils for magnetically biasing the core. In some of these other embodiments, the magnetically biasing system is located adjacent or located closely adjacent to the core to provide the magnetic bias.

In some embodiments, the magnetically biasing system includes a greater or lesser number of DC coils. Moreover, in some embodiments, the DC coils are constructed from other than HTS. For example, in specific embodiments, use is made of DC coils constructed from copper-based material such as a copper alloy or electrical grade copper.

The movement of AC coils 20, 21 and 22 from a low impedance to a high impedance state increases the impedance in the current path through which I_{LOAD} must flow. This limits I_{LOAD} as V_{S} and V_{T} are relatively tightly controlled. It will be appreciated that FCL 6 is designed such that, in use, I_{LOAD} is limited to no more than I_{MAX}. This ensures that the current carried by transformer 2 is limited which, in turn, provides overload protection for that transformer.

In the embodiment of FIG. 2, core 14 includes three pairs of parallel elongate longitudinally coextensive like posts 15, where pairs of adjacent posts are associated with respective phases. The posts 15 have a substantially constant and uniform transverse cross-section that is irregular. In this embodiment, the irregular transverse cross-section of the posts is substantially “pie-shaped” or “wedge-shaped”. That is, each post has two substantially planar surfaces that meet at an inner common edge and which extend divergently outwardly from each other and terminate at opposite edges of an adjoining generally curved outer surface. The posts 15 are arranged relative to each other such that adjacent planar surfaces of adjacent posts are opposed. This results in the posts collectively defining a generally cylindrical but segmented core 14 having a notional longitudinal axis 25. It will be noted that in this embodiment the posts are equally angularly spaced about this axis.

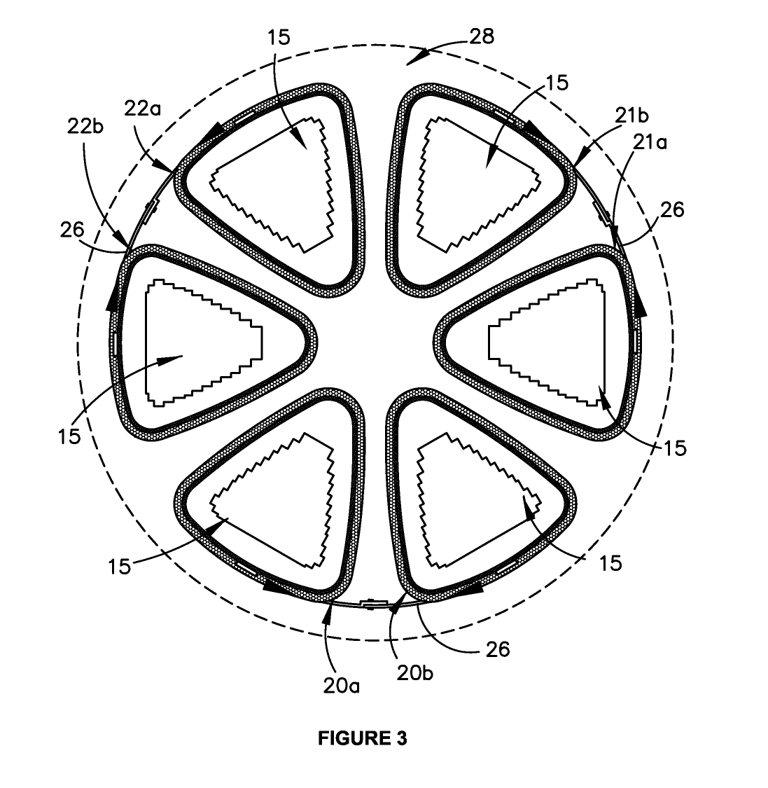

In this particular embodiment, the pairs of posts are located adjacent to one another, as best shown in FIG. 3. The two coil segments 20a and 20b, 21a and 21b, and 22a and 22b of each AC coil 20, 21 and 22 respectively are also located adjacent to one another. Adjacent coil segments are electrically connected via a bridge 26. That is, in this embodiment, the posts associated with each phase of the three phase system are located adjacent one another.

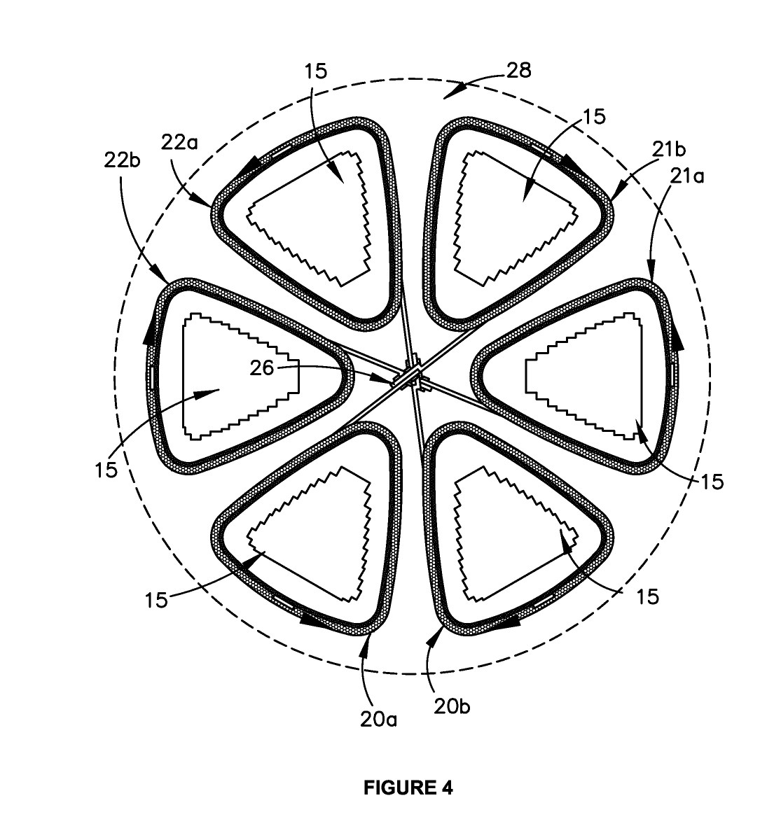

In other embodiments, it will be appreciated that the posts in each pair of posts are arranged other than adjacent to each other. For example, in the embodiment of FIG. 4, the posts in each pair of posts are located opposite to one another, in that they are diametrically opposed about axis 25. The pairs of coil segments 20a and 20b, 21a and 21b, and 22a and 22b of each AC coil 20, 21 and 22 respectively are also diametrically opposed to one another. In this case, bridge 26 is used to electrically connect the opposing coil segments.

Other embodiments include posts that have other than a substantially constant and uniform transverse cross-section.

The posts 15 are constructed with stacked transformer steel laminations. In other embodiments, use is made of one or more of mild steel or other forms of magnetic steel ferrite materials or ferromagnetic material or granular material such as a core made from consolidated ferromagnetic powder, or a glassy amorphous core.

Referring again to FIG. 2, posts 15 and associated AC coils 20, 21 and 22 are all housed within a single tank 27 containing a dielectric medium 28. Each DC coil 12 is housed in a separate cryogenic chamber 29 located outside the oil tank 27.

In other embodiments, the DC coils are also housed within the oil tank 27 and immersed within a common dielectric medium 28. This arrangement is particularly applicable to embodiments where the DC coils are formed of copper, copper alloy or other suitable conductor.

In other embodiments use is made of a single cryogenic chamber for both coils, or a single cryogenic chamber for a single DC coil.

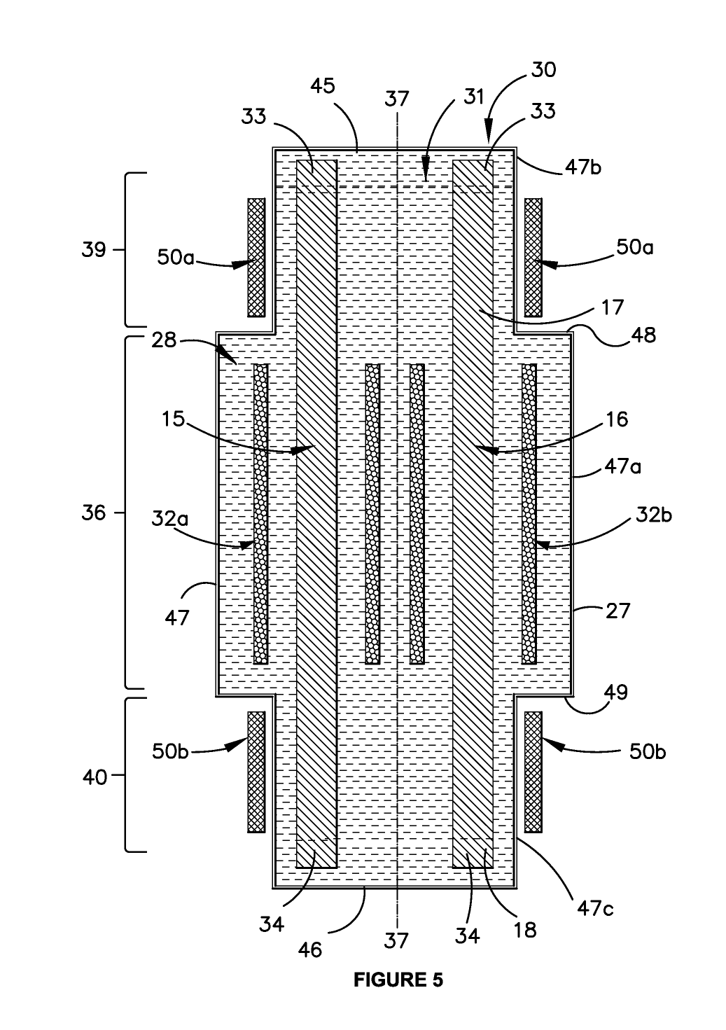

FIG. 5 shows a single phase FCL 30 including a magnetically saturable core 31 having a single longitudinally extending first portion 16 and a single second portion 17 that extends longitudinally beyond the portion 16. Third portion 18 extends longitudinally beyond portion 16. FCL 30 includes an AC coil 32 wound about portion 16.

Core 31 includes a pair of parallel elongate longitudinally coextensive like posts 15. Posts 15 each have a first end 33 and a second end 34 that is spaced apart from the respective first ends. Posts 15 are arranged such that the ends 33 are adjacent with each other and collectively define portion 17, and ends 34 are adjacent with each other to collectively define portion 18.

AC coil 32 has two coil segments 32a and 32b that are oppositely wound about respective portions 16. Posts 15 and AC coils 32 are housed within tank 27 and immersed within dielectric medium 28.

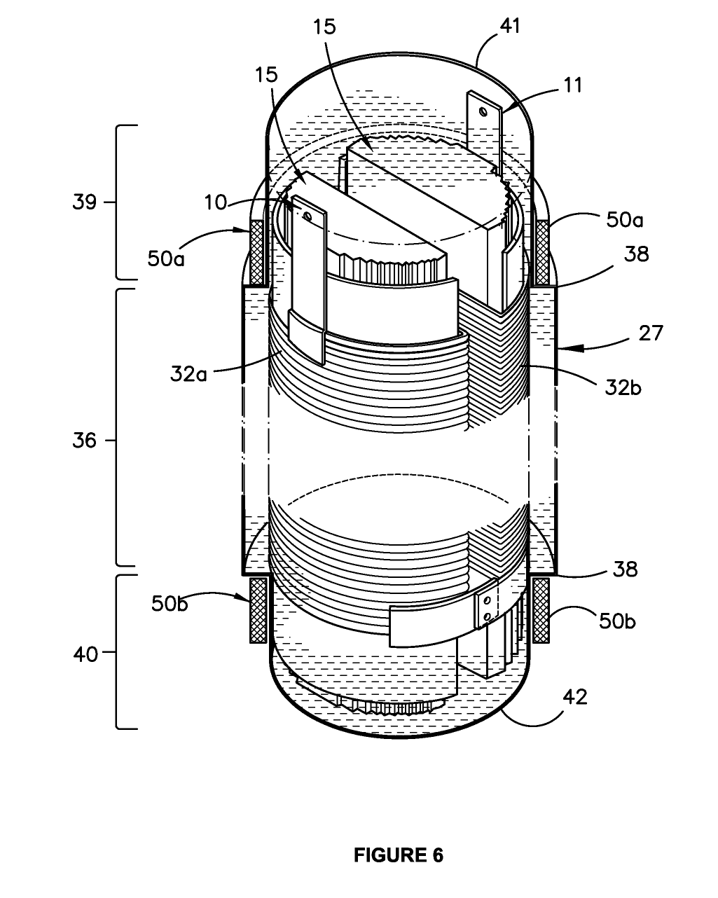

Tank 27 includes a generally cylindrical longitudinally extending first zone 36 for receiving portion 16 and having a longitudinal axis 37. As best shown in FIG. 6, zone 36 has a predetermined generally circular first transverse footprint 38. Tank 27 further includes a generally cylindrical second zone 39 that is coaxial with and extends longitudinally upwardly from zone 36. A generally cylindrical third zone 40 is coaxial with and extends longitudinally downwardly from zone 36. Zones 39 and 40 respectively receive portions 17 and 18 and zones 39 and 40 have respective predetermined equal and overlying transverse generally circular footprints 41 and 42 that are substantially equal and which are not greater than footprint 38.

It will be appreciated that in other embodiments, the zones are other than generally cylindrical and the footprints are other than circular in cross section. In other embodiments, footprints 41 and 42 are substantially equal and overlying with footprint 38.

Referring again to FIG. 5, tank 27 includes a generally circular substantially planar, opposed and parallel top and bottom surfaces 45 and 46, and a longitudinally extending outer wall 47. The outer wall includes three sub-walls 47a, 47b and 47c which respectively define footprints 38, 41 and 42. An annular substantially horizontal wall 48 is integrally formed with and extends transversely between sub-wall 47a and 47b, while an annular substantially horizontal wall 49 is integrally formed with and extends transversely between sub-wall 47a and 47c. Zone 36 lies within sub-wall 47a and extends longitudinally between walls 48 and 49. Zone 39 extends upwardly from zone 36 to surface 45, and is bounded by sub-wall 47b. Zone 40 extends downwardly from zone 36 to surface 46, and is bounded by sub-wall 47c.

Similarly to the FIG. 2 embodiment, FCL 30 includes a magnetically biasing system having two longitudinally spaced apart DC coils 50a and 50b that are wound about and closely adjacent to respective portions 17 and 18 for magnetically biasing core 31 such that, in response to one or more characteristics of the load current I_{LOAD}, AC coil 32 moves from a low impedance state to a high impedance state. In this particular embodiment, coils 50a and 50b are closely adjacent to respective portions 17 and 18 such that the DC coils do not transversely extend beyond sub-wall 47a. That is, the width of each DC coil 50 is no more than the radial or transverse length of sub-walls 48 and 49. In other words, coils 50a and 50b have equal and overlying transverse footprints that are less than the transverse footprint 38, as best shown in FIG. 6. The footprint of DC coils 50a and 50b are substantially coextensive with footprints 38, 41 and 42. It will be appreciated by those skilled in the art that the footprints of the DC coils, in use, lie wholly within footprint 38.

Again, it will be appreciated that in other embodiments, the magnetically biasing system includes other than DC coils for magnetically biasing the core. In some embodiments, DC coils 50a and 50b have a notional inner surface with a predetermined footprint and AC coil 32 has a notional outer surface with a predetermined footprint that extends beyond the footprint of the notional inner surface of DC coils 50a and 50b.

In some embodiments of the invention, the magnetically biasing system is located adjacent the core such that the biasing system is in abutment with the core. For example, in embodiments where the biasing system is in the form of at least one DC coil housed within the tank and immersed within a common dielectric, the DC coil is located closely adjacent the core such that it abuts the core. In some embodiments where the DC coil is housed in a cryogenic chamber located outside the tank, the DC coil is located closely adjacent to the core such that the DC coil abuts the cryogenic chamber, the chamber abuts the tank and the tank abuts the core. It will be appreciated that in some embodiments where the DC coil is housed in a cryogenic chamber, the DC coil, cryogenic chamber, tank and core are not all in abutment. That is, one or more of the DC coil, cryogenic chamber, tank and core are in abutment, but not all. It will be appreciated that these abovementioned embodiments also apply where the magnetically biasing system includes more than one DC coil and where the biasing system is other than a DC coil. As a specific example with reference to FIG. 5, in a similar embodiment, DC coil 50a is wound about and closely adjacent to portion 17 such that coil 50a abuts sub-wall 47b and sub-wall 47b abuts portion 17. Provided a predetermined electrostatic clearance is maintained between the AC coil and the tank in a longitudinal direction, in some embodiments, the magnetically biasing system is located adjacent the core such that the biasing system is as close to being in abutment with the core as possible.

Referring to FIG. 5, DC coil 50a is closely adjacent to portion 17 such that the distance between coil 50a and sub-wall 47b is less than the distance between coil 50a and sub-wall 47a. Similarly, coil 50b is closely adjacent to portion 18 such that the distance between coil 50b and sub-wall 47c is less than the distance between coil 50b and sub-wall 47a.

It will be appreciated that in other embodiments, the distance between DC coil 50a and sub-wall 47b need not necessarily be less than the distance between DC coil 50a and sub-wall 47a. Similarly, the distance between DC coil 50b and sub-wall 47c need not necessarily be less than the distance between DC coil 50b and sub-wall 47a.

Referring to FIG. 6, in other embodiments, it will be appreciated that transverse footprints of coils 50a and 50b are substantially the same as transverse footprint 38 of zone 36.

In this specification there are descriptions of specific embodiments that use relative terms such as “upper”, “lower”, “top”, “base” and the like. This originates from the primary installed orientation of the FCL being an upright or vertical configuration as shown in the Figures. It will be appreciated by those skilled in the art that for some installations, where the vertical packaging constraints are the key limitation, that the FCLs of the embodiments are able to be orientated in a horizontal configuration. Accordingly, in such embodiments, the relative terms mentioned above need to be read in the context of the orientation of the FCL. It will also be appreciated that, in other embodiments, the FCL is inclined with respect to both the vertical and horizontal configurations mentioned above.

In some embodiments, the AC coils require a predetermined physical clearance to an electrical earth and the DC coils are spaced apart from the core by less than the predetermined clearance.

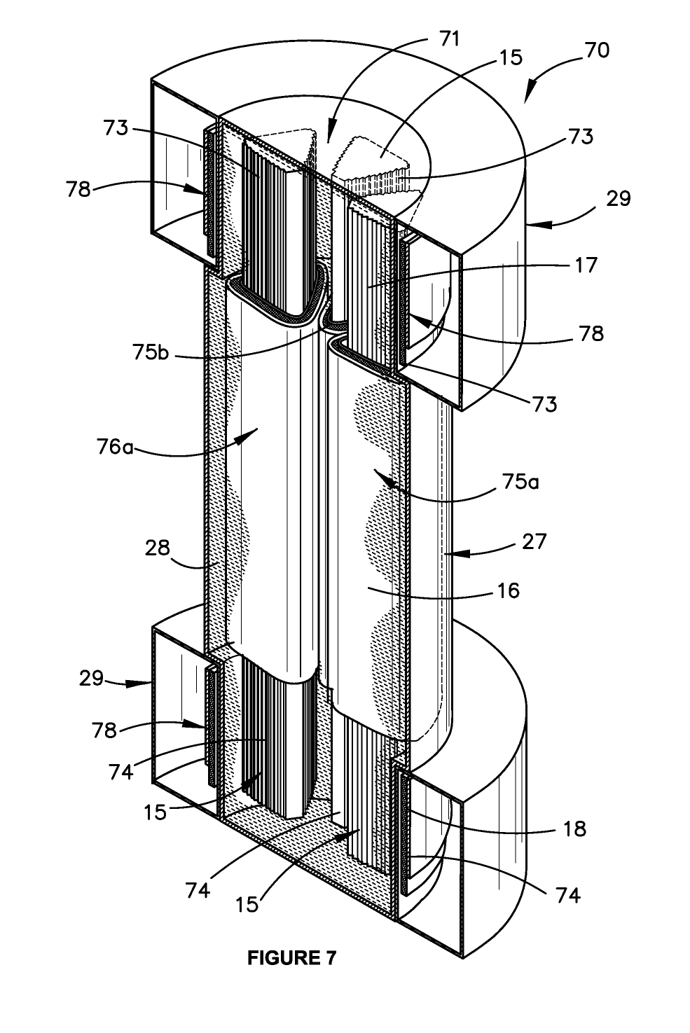

FIG. 7 shows a three phase FCL 70 including a magnetically saturable core 71 having longitudinally extending first portion 16 and second portion 17 that extends longitudinally beyond the portion 16. A third portion 18 extends longitudinally beyond portion 16 although in the opposite direction to that of portion 17. Core 71 includes three pairs of parallel elongate longitudinally coextensive “pie-shaped” posts 15 (only three posts are shown for the sake of clarity). The posts each have a first end 73 and a second end 74 and are arranged such that: ends 73 are adjacent with each other and collectively define portion 17; and ends 74 are adjacent with each other to collectively define portion 18.

FCL 70 includes three AC coils wound about portion 16, where each coil has two coil segments. While in FIG. 7 only three coil segments 75a, 75b and 76a are shown, it will be appreciated that FCL includes three others to provide the required current limiting functionality for the three phases of the electrical load. Segments 75a and 75b are oppositely wound about respective portions 16.

The six posts 15 and all the six coil segments are housed entirely within the oil tank 27 which contains a dielectric medium such as transformer oil, vegetable oil, or synthetic ester 28.

FCL 70 includes a magnetically biasing system having two longitudinally spaced apart HTS DC coils 78 wound about and closely adjacent to respective portions 17 and 18 for magnetically biasing core 71 such that, in response to one or more characteristics of the load current I_{LOAD}, the coil segments move from a low impedance state to a high impedance state. Each DC coil 78 is housed in cryogenic chamber 29 located outside tank 27.

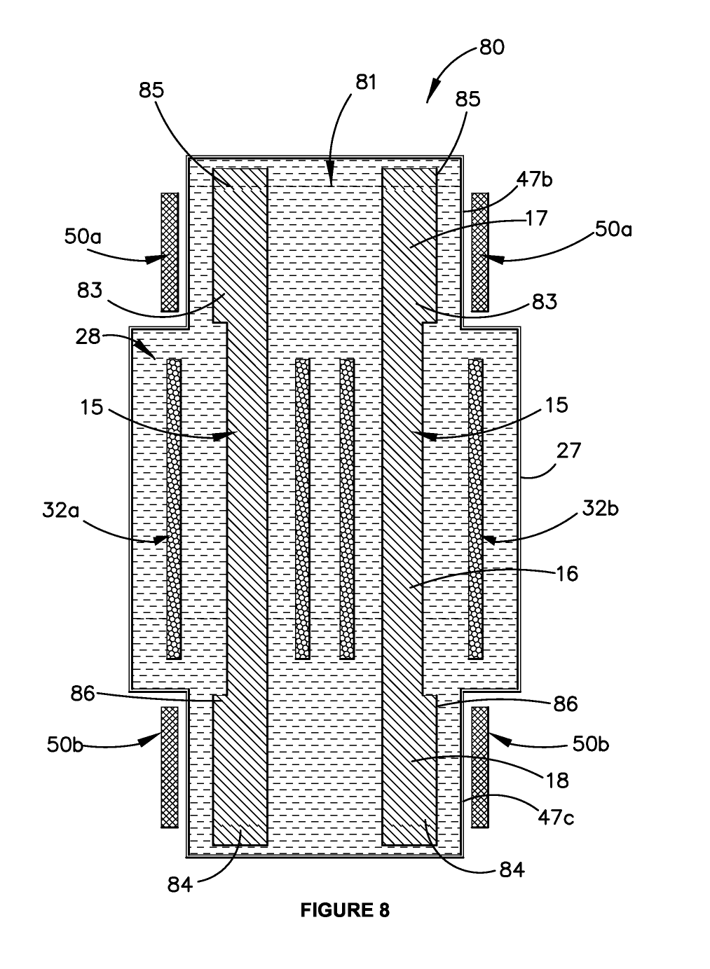

FIG. 8 shows a single phase FCL 80 similar to FIG. 5 but having a magnetically saturable core 81 that is substantially non-uniform in transverse cross-section. Core 81 includes a pair of parallel elongate longitudinally coextensive posts 15. The posts each have a first end 83 and a second end 84 and posts 15 are arranged such that the ends 83 are adjacent with each other and collectively define portion 17. Ends 84 are adjacent with each other to collectively define portion 18. Ends 83 and 84 are flared such that respective outer edges 85 and 86 of ends 83 and 84 extend uniformly transversely outwardly beyond portion 16. In this embodiment, outer edges 85 and 86 are more closely adjacent to sub-walls 47b and 47c than in embodiments where posts 15 have a substantially constant and uniform transverse cross-section.

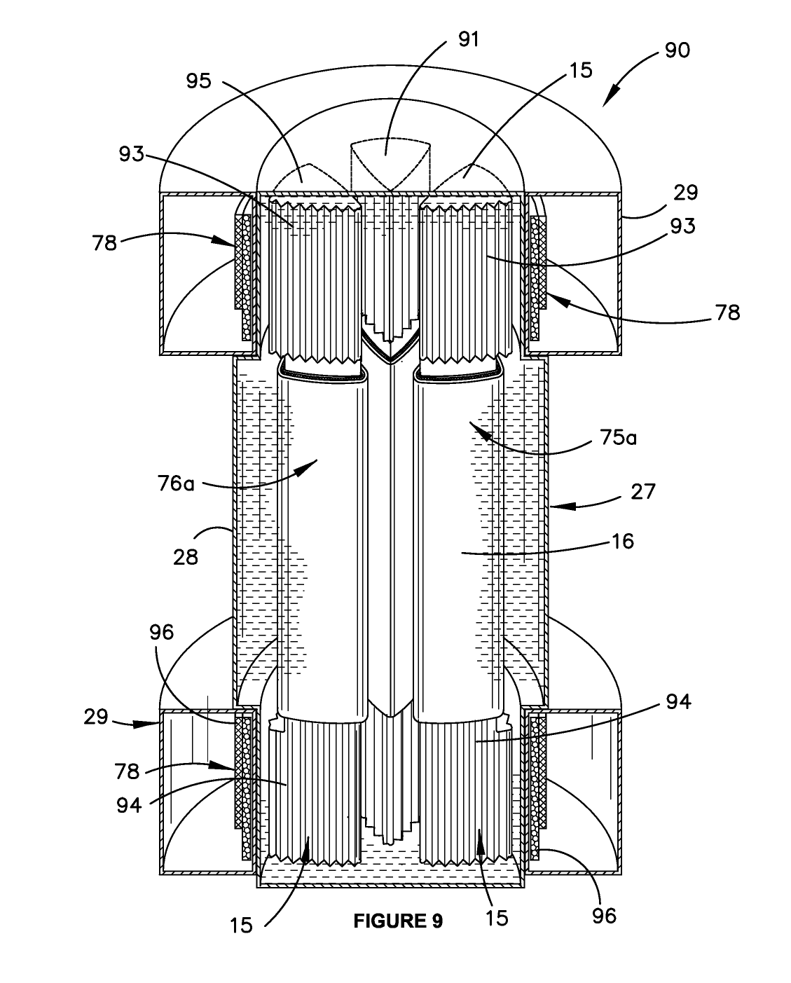

FIG. 9 shows a three phase FCL 90 including a magnetically saturable core 91 having three pairs of parallel elongate longitudinally coextensive “pie-shaped” posts 15 (only three posts are shown). Similarly to the FIG. 8 embodiment, core 91 is substantially non-uniform in transverse cross-section. That is, ends 93 and 94 of the transverse cross section of posts 15 is non-uniform in that the posts are flared. More particularly, the respective outer edges 95 and 96 of ends 93 and 94 of posts 15 extend uniformly transversely beyond portion 16. Ends 93 and 94 extend transversely radially outwardly beyond portion 16 to define the substantially non-uniform cross-section of core 91.

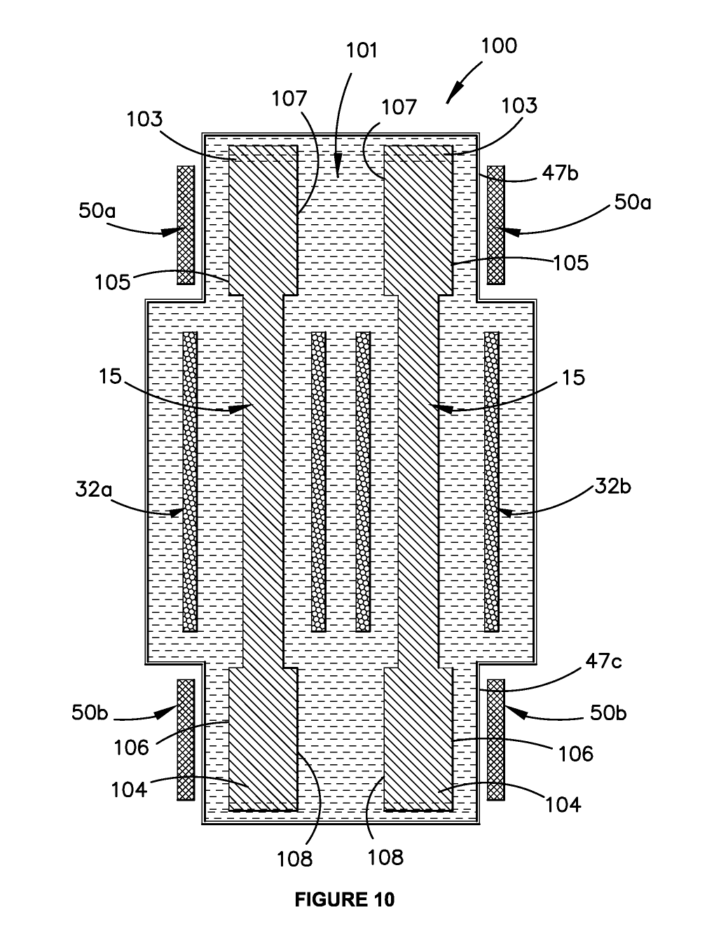

FIG. 10 shows a single phase FCL 100 similar to the embodiment of FIG. 8 having a magnetically saturable core 101 that is substantially non-uniform in transverse cross-section. However, in this case, ends 103 and 104 of posts 15 are flared such that the respective outer edges 105 and 106 and the respective inner edges 107 and 108 of ends 103 and 104 respectively extend uniformly transversely outwardly and inwardly beyond portion 16. In this embodiment, outer edges 105 and 106 are again more closely adjacent to sub-walls 47b and 47c than in embodiments where posts 15 are not flared. That is, where the posts have a substantially constant and uniform transverse cross-section.

It will be appreciated that in other embodiments, ends 103 and 104 are flared other than having the outer edges 105 and 106 and the inner edges 107 and 108 of ends 103 and 104 respectively extend uniformly transversely outwardly and inwardly beyond portion 16. For example, in some embodiments, ends 103 and 104 are flared such that the outer edges 105 and 106 and the inner edges 107 and 108 respectively extend transversely outwardly and inwardly beyond portion 16, but not uniformly. Furthermore, in other embodiments, it will be appreciated that the posts are configured in other ways such that the core is substantially non-uniform in cross-section.

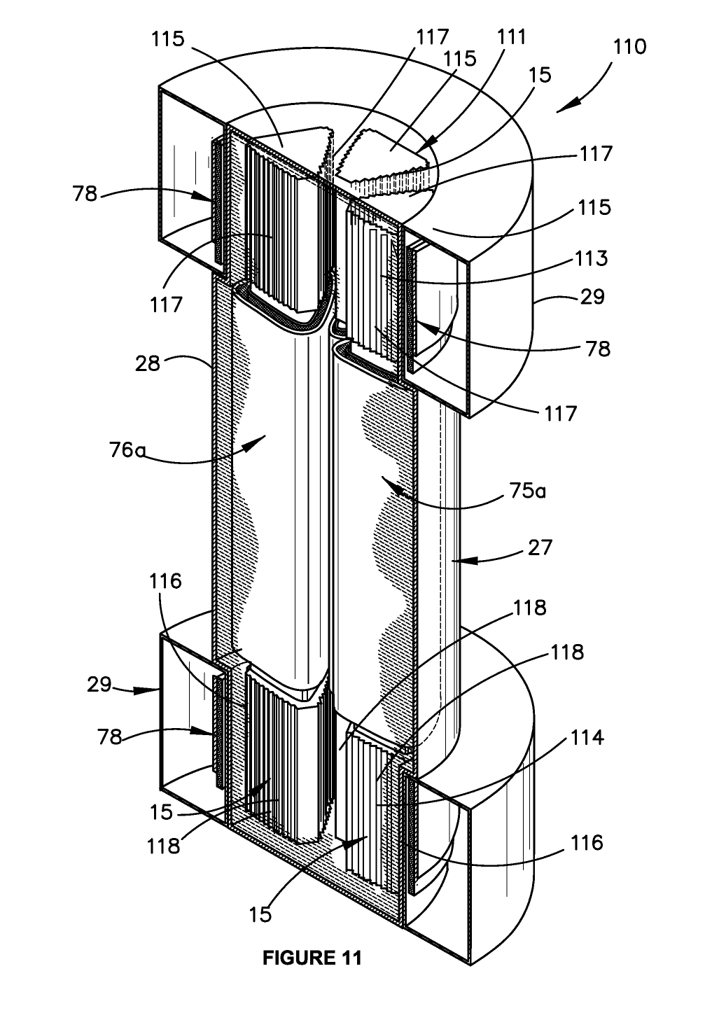

FIG. 11 shows a three phase FCL 110 including a magnetically saturable core 111 having three pairs of parallel elongate longitudinally coextensive “pie-shaped” posts 15 (only three posts are shown). Similarly to the FIG. 10 embodiment, core 111 is substantially non-uniform in transverse cross-section. That is, ends 113 and 114 of posts 15 are flared such that the respective outer edges 115 and 116 and the respective inner edges 117 and 118 of ends 113 and 114 respectively extend uniformly transversely outwardly and inwardly beyond portion 16.

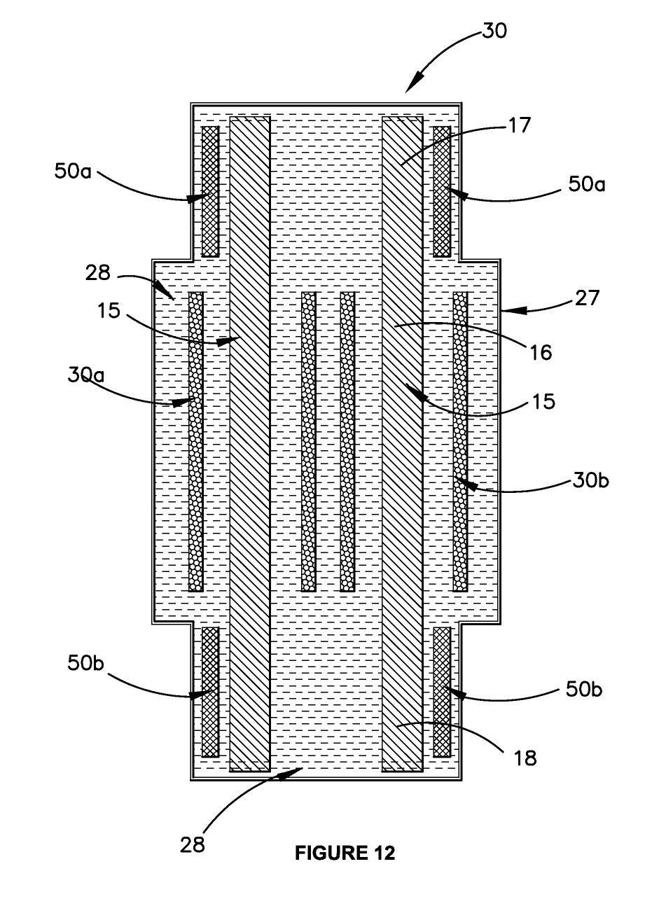

FIG. 12 shows a single phase FCL 30 similar to the embodiment of FIG. 5. However, in this case, FCL 30 includes a magnetically biasing system having DC coils 50a and 50b formed of copper, copper alloy or other suitable conductor. The DC coils are housed within tank 27 and immersed within a common dielectric medium 28.

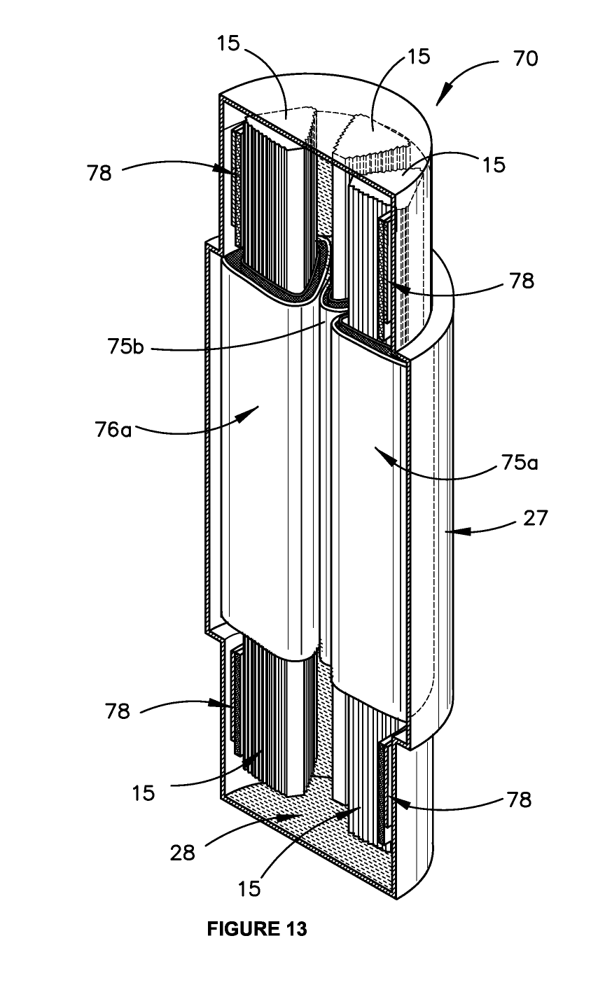

FIG. 13 shows a three phase FCL 70 similar to the embodiment of FIG. 7 but having a magnetically biasing system including DC coils 78 formed of copper, copper alloy or other suitable conductor. As with the embodiment of FIG. 12, the DC coils are housed within tank 27 and immersed within a common dielectric medium 28.

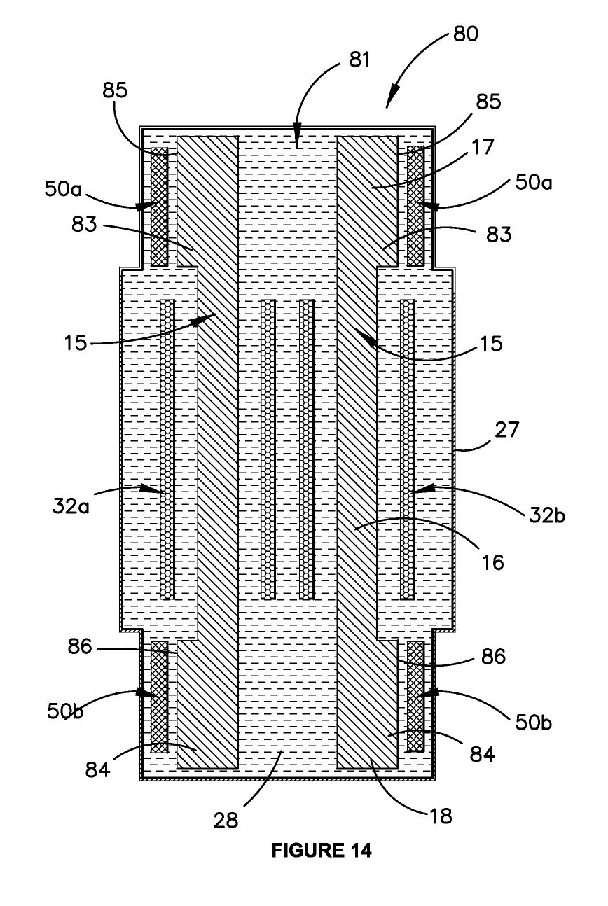

FIG. 14 shows a single phase FCL 80 similar to FIG. 8 having a magnetically saturable core 81 that is substantially non-uniform in transverse cross-section. Ends 83 and 84 of posts 15 are flared as with the embodiment of FIG. 8. In this embodiment, FCL 80 includes a magnetically biasing system having DC coils 50a and 50b formed of copper, copper alloy or other suitable conductor. DC coils 50 a and 50b are housed within tank 27 and immersed within a common dielectric medium 28.

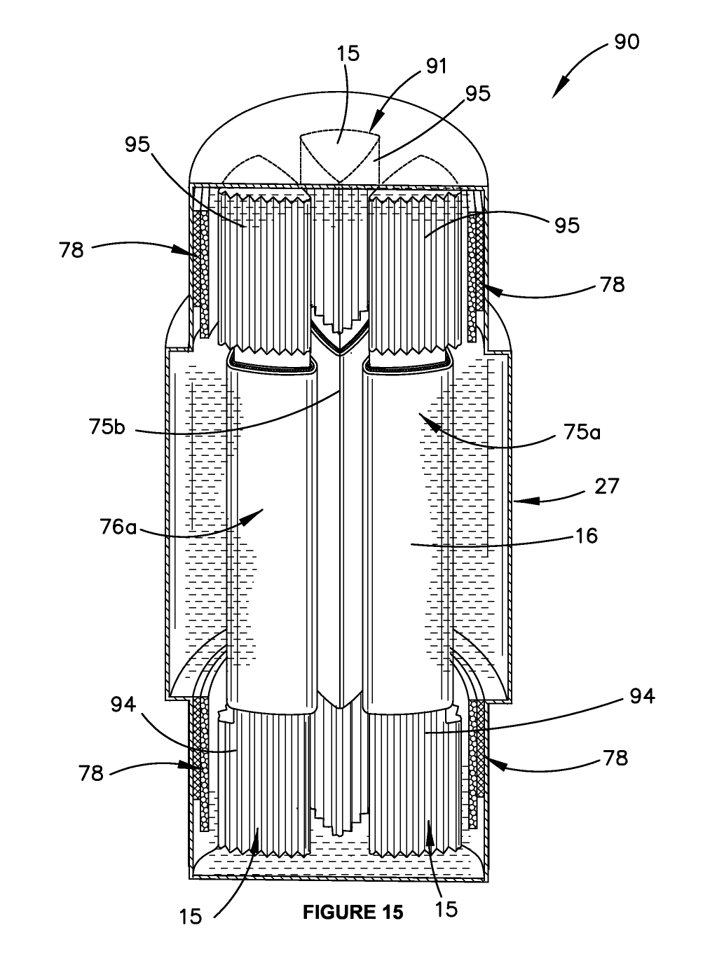

FIG. 15 shows a three phase FCL 90 similar to the embodiment of FIG. 9 including a substantially non-uniform in transverse cross-section magnetically saturable core 91 having three pairs of parallel elongate longitudinally coextensive “pie-shaped” posts 15 (only three posts are shown). As with the embodiment of FIG. 14, DC coils 78 are formed of copper, copper alloy or other suitable conductor and are housed within tank 27 and immersed within a common dielectric medium 28.

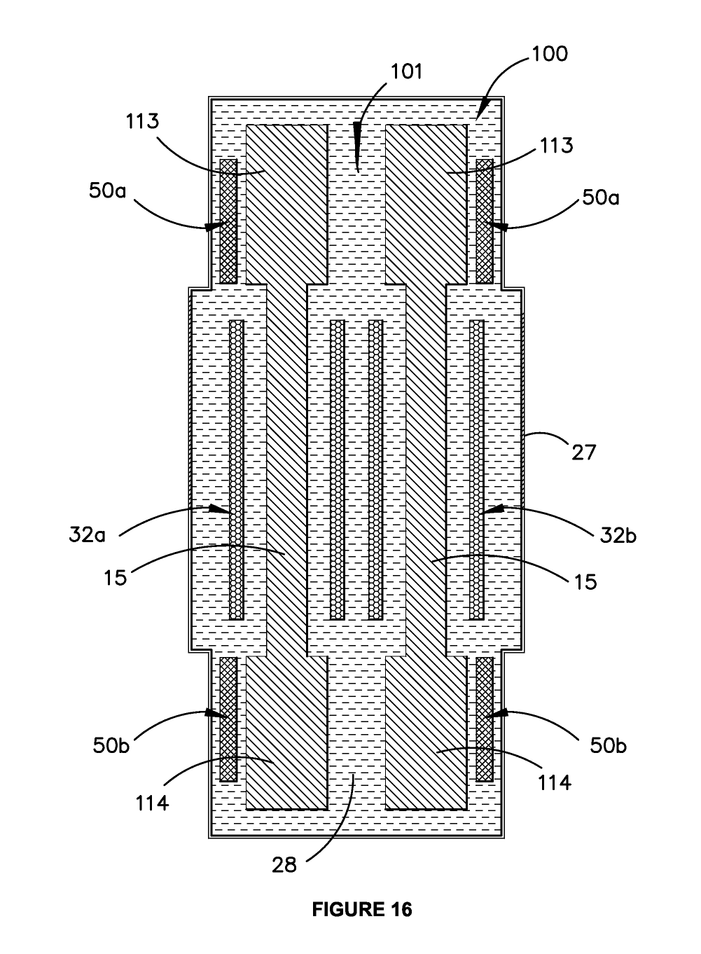

FIG. 16 shows a single phase FCL 100 similar to the embodiment of FIG. 10 having a magnetically saturable core 101 that is substantially non-uniform in transverse cross-section. Ends 113 and 114 of posts 15 are flared as with the embodiment of FIG. 10. FCL 100 includes a magnetically biasing system having DC coils 50a and 50b formed of copper, copper alloy or other suitable conductor. The DC coils are housed within tank 27 and immersed within a common dielectric medium 28.

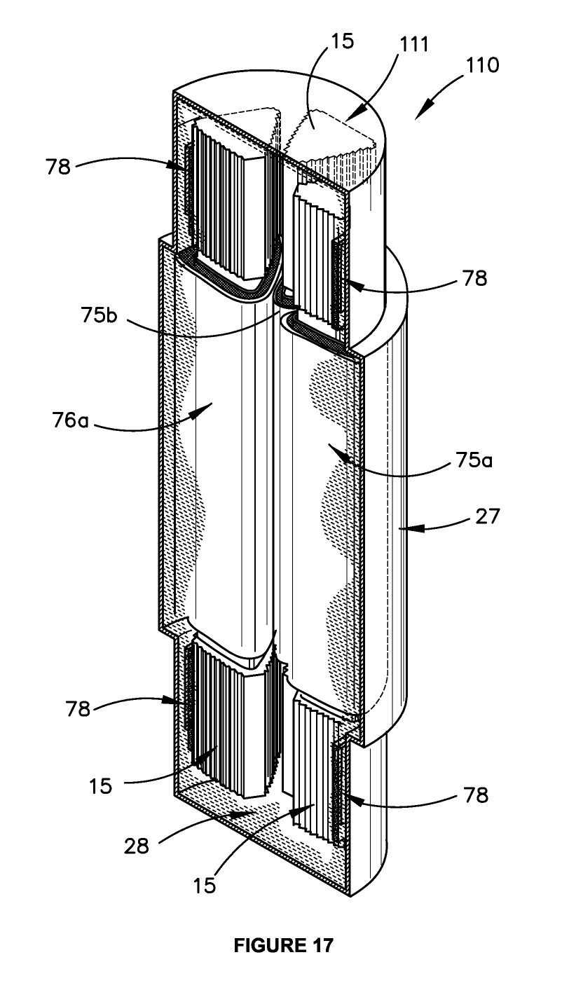

FIG. 17 shows a three phase FCL 110 similar to the embodiment of FIG. 11 including a magnetically saturable core 111 having three pairs of parallel elongate longitudinally coextensive “pie-shaped” posts 15 (only three posts are shown). DC coils 78 are formed of copper, copper alloy or other suitable conductor and are housed within tank 27 and immersed within a common dielectric medium 28.

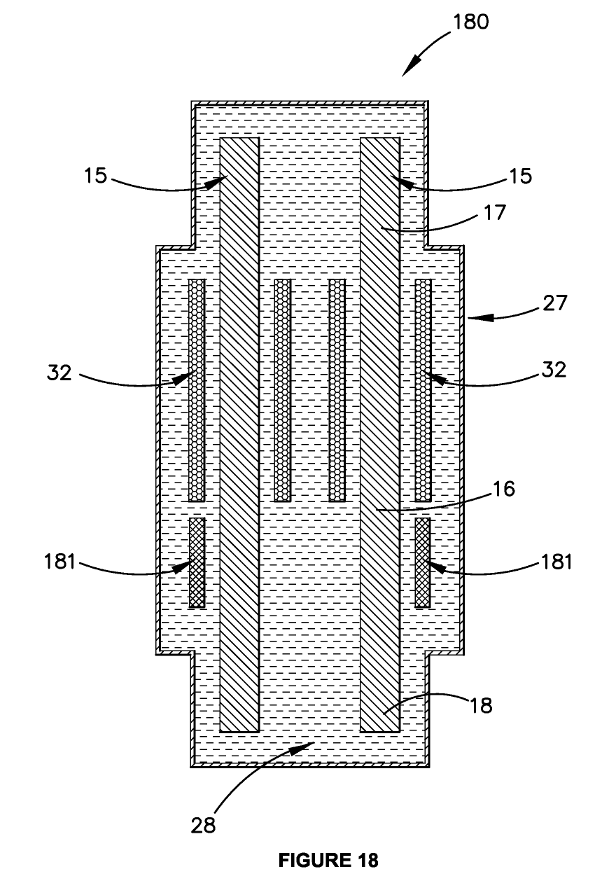

FIG. 18 shows a single phase FCL 180 similar to the embodiment of FIG. 12. However, in this case, FCL 180 includes a magnetically biasing system having a single DC coil 181 wound about and closely adjacent to portion 16 and longitudinally spaced from AC coil 32. In this particular embodiment, DC coil 181 is housed within tank 27 and immersed within a common dielectric medium 28. However it will be appreciated that in other embodiments, DC coil 181 is located outside tank 27. In some embodiments, DC coil 181 is housed in a cryogenic chamber located outside tank 27. Furthermore, it will be appreciated that in other embodiments, DC coil 181 is wound about and closely adjacent to either portion 17 or portion 18, such that the DC coil remains longitudinally spaced from AC coil 32.

In other embodiments, it will be appreciated that the magnetically biasing system includes other than a DC coil for magnetically biasing the core.

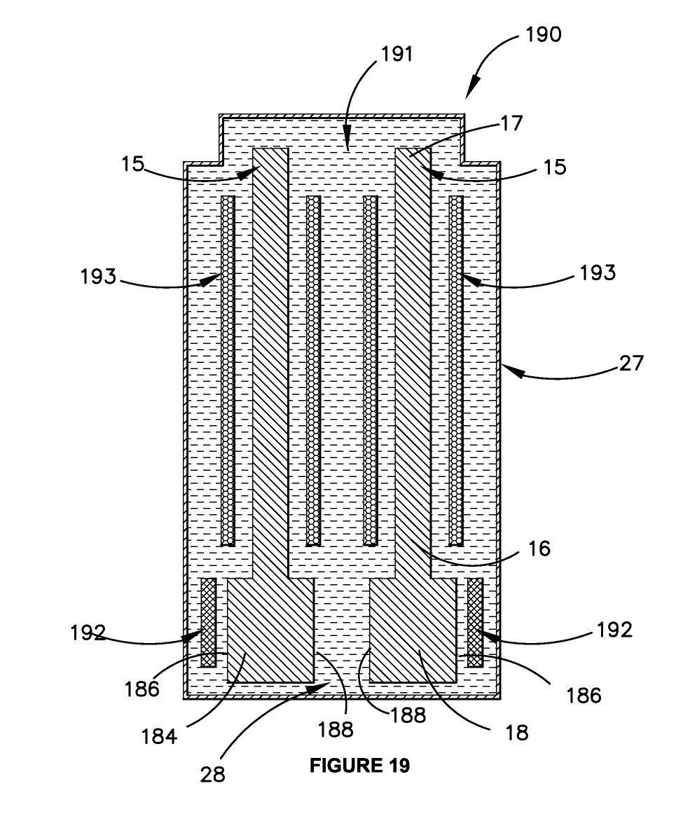

FIG. 19 shows a single phase FCL 190 having a magnetically saturable core 191 that is substantially non-uniform in transverse cross-section, and a magnetically biasing system having a single DC coil 192. In this case, end 184 of posts 15 are flared such that the outer edges 186 and the inner edges 188 respectively extend uniformly transversely outwardly and inwardly beyond portion 16. DC coil 192 is wound about and closely adjacent to portion 18 and longitudinally spaced from AC coil 193. In this particular embodiment, DC coil 192 is housed within tank 27 and immersed within a common dielectric medium 28. However it will be appreciated that in other embodiments, DC coil 192 is located outside tank 27. In some embodiments, DC coil 192 is housed in a cryogenic chamber located outside tank 27. Furthermore, it will be appreciated that in other embodiments, DC coil 192 is wound about and closely adjacent to either portion 16 or portion 18, such that the DC coil remains longitudinally spaced from AC coil 193.

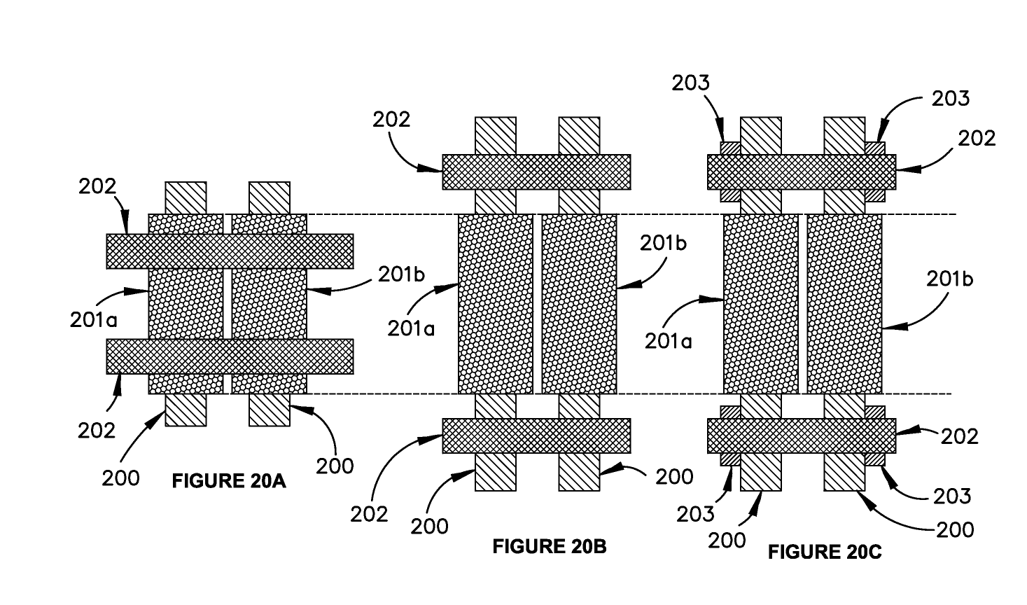

Three single phase FCLs are shown in FIGS. 20A, 20B and 20C with identical AC coils in each. The FCLs include a pair of parallel elongate longitudinally coextensive posts 200, an AC coil 201 having two coil segments 201a and 201b and two DC coils 202. In FIG. 20C, posts 200 include flared portions 203. The FCLs include the following:
Steel core material: M4
Thickness of steel core laminations=0.3 mm
Cross sectional dimensions of steel core=80 mm×80 mm
Number of AC turns on each steel core: N_{AC}=60 turns
Cross sectional area of each steel core: A_{CORE}=0.0064 m²
Number of DC turns: N_{DC}=400
Height of each AC coil: H_{AC}=390 mm
The DC and AC coils were manufactured from electrical grade copper conductor with a rectangular cross section of dimensions 14 mm×4 mm.

The DC coil separation in each FCL is:
a) FCL of FIG. 20A: 312 mm
b) FCL of FIG. 20B: 420 mm
c) FCL of FIG. 20C: 420 mm

The steel core height, H_{CORE}, in each FCL is:
a) FCL of FIG. 20A: 600 mm
b) FCL of FIG. 20B: 1200 mm
c) FCL of FIG. 20C: 1200 mm

The dimensions of additional laminated steel core flared portions of FIG. 20C are 80 mm×80 mm×200 mm long and were manufactured from the same core material as the posts. Hence, in the FCL of FIG. 20C, the flared end portions 203 of posts 200 had overall dimensions of 160 mm×80 mm×200 mm.

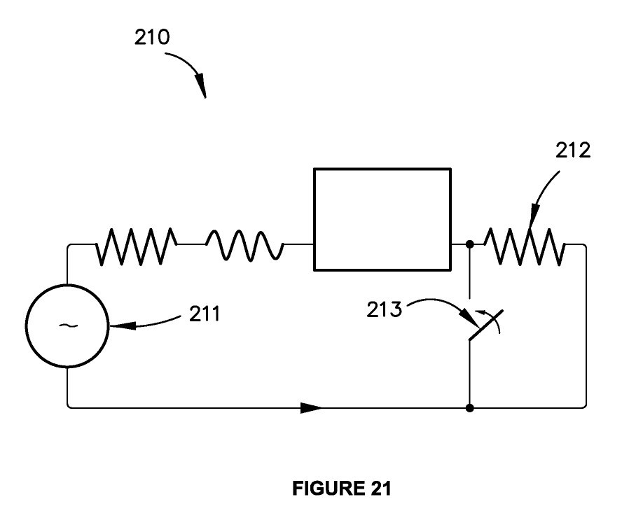

Referring to FIG. 21, the test circuit 210 has the following parameters:
Test voltage 211: V_{AC}=312 Volts AC rms line-to-neutral
Frequency of voltage source=50 Hz
Load resistance 212 of AC test circuit: R_{LOAD}=9.6 Ohms

The switch 213 in the test circuit is closed after allowing the circuit to come to steady state. The prospective fault current is measured with the steel cores taken out of the structure and only the AC coils remaining in the circuit.

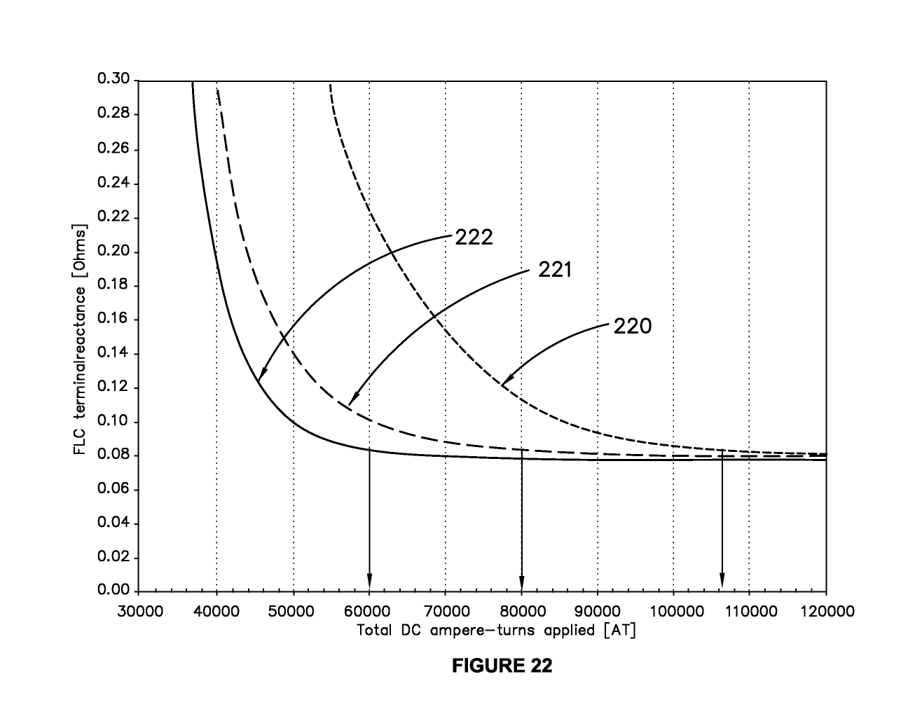

FIG. 22 shows the DC bias characteristic 220, 221 and 222 of respective FCLs of FIGS. 20A, 20 B and 20C. Table 1 details the DC bias values which were found to reach an AC impedance of 0.12 Ohms and 0.08 Ohms respectively on each in the steady state un-faulted condition. That is to say, before the fault is applied to the circuit in FIG. 21. The results indicate that the FCLs of FIGS. 20B and 20C offer advantages over the FCL of FIG. 20A in that not only is the fault current limiting improved but the DC bias required to reach a certain impedance is reduced with the least DC bias achieved by the FCL of FIG. 20C.

TABLE 1

| | | DC Bias required to reach | DC Bias required to reach |
|---|---|---|---|
| | | an FCL impedance of 0.12 | an FCL impedance of 0.08 |
| | | Ohms in the steady state | Ohms in the steady state |
| FCL | Details | un-faulted condition [kAT] | un-faulted condition [kAT] |
| FIG. 20A | A single phase FCL wherein | 78 | 108 |
| | the DC coils extend about | | |
| | the posts and AC coil | | |
| FIG. 20B | A single phase FCL | 54 | 80 |
| | according to an embodiment | | |
| | of the invention | | |
| FIG. 20C | A single phase FCL | 45 | 62.6 |
| | according to another | | |
| | embodiment of the invention | | |
| | with substantially non- | | |
| | uniform steel core cross- | | |
| | sectional area | | |

Fault current experiments were carried out on the FCLs of FIGS. 20A, 20B, and 20C at the two sets of common FCL impedance values as detailed in Table 1.

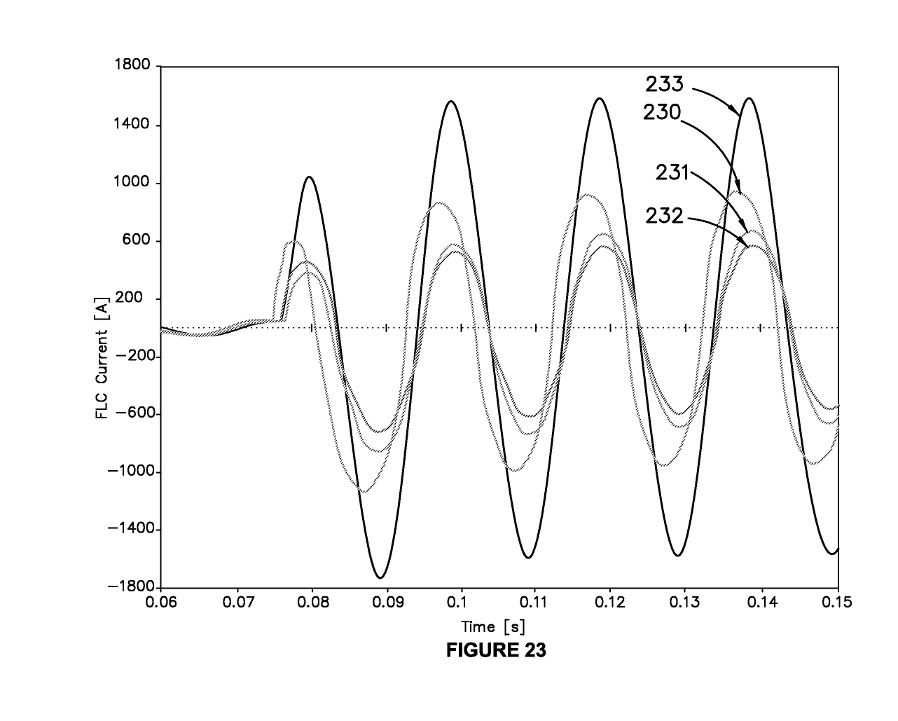

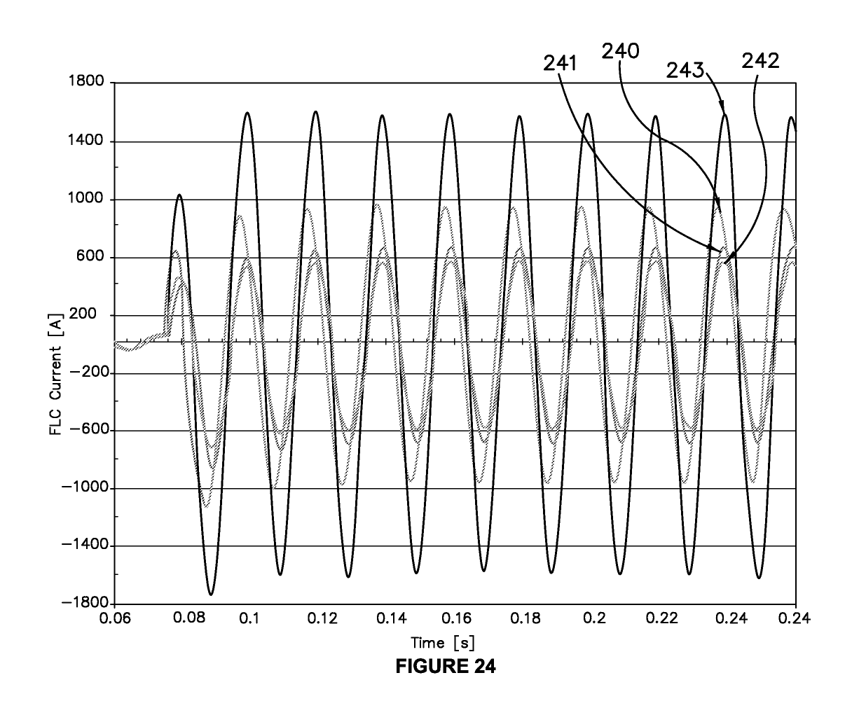

Referring to FIG. 23, waveform 230 shows the fault current waveform at a DC bias of 108,000 Ampere-turns and an FCL impedance of 0.08 Ohms, from the FCL constructed according to FIG. 20A. Waveform 231 shows the fault current at a DC bias of 80,000 Ampere-turns and an FCL impedance of 0.08 Ohms from the FCL constructed according to FIG. 20B. Waveform 232 illustrates the fault current at a DC bias of 60,000 Ampere-turns and an FCL impedance of 0.08 Ohms from the FCL constructed according to FIG. 20C. Finally, waveform 233 shows the fault current when the high permeability posts 200 are removed. The Waveform 233 allows a comparison of the effectiveness of the high permeability cores on the fault current limiting ability of each FCL to be assessed. The same waveform 233 is applicable to all three constructions of FIGS. 20A, 20B, and 20C because the AC coils are identical in these three FCLs. The set of waveforms 230, 231, 232, and 233 clearly show that the FCL constructed in FIG. 20C, with the substantially non-uniform steel core area, is the most effective at limiting fault current.

Table 2 summarises the steady state fault current results obtained on the FCLs illustrated in FIGS. 20A, 20B, and 20C where they are biased such that the FCL impedance is 0.08 Ohms for each.

In a similar way, fault current experiments were carried out on the FCLs of FIGS. 20A, 20B, and 20C with a constant impedance of 0.12 Ohms.

Table 3 summarises the steady state fault current results obtained on the FCLs illustrated in FIGS. 20A, 20B, and 20C where they are biased such that the FCL impedance is 0.12 Ohms for each.

TABLE 2

| | | DC Bias required to reach | Prospective | Limited fault |
|---|---|---|---|---|
| | | a FCL impedance of 0.12 | fault current | current with FCL |
| | | Ohms before the fault is | with no steel | in circuit and |
| | | applied to the circuit in | core present | with steel cores |
| FCL | Details | FIG. 21 [kAT] | rms [A] | present rms [A] |
| FIG. 20A | A single phase FCL | 78 | 1100 | 651 |
| | wherein the DC coils | | | |
| | extend about the posts | | | |
| | and AC coil | | | |
| FIG. 20B | A single phase FCL | 54 | 1100 | 464 |
| | according to an | | | |
| | embodiment of the | | | |
| | invention | | | |
| FIG. 20C | A single phase FCL | 45 | 1100 | 395 |
| | according to another | | | |
| | embodiment of the | | | |
| | invention with | | | |
| | substantially non- | | | |
| | uniform steel core | | | |
| | cross-sectional area | | | |

TABLE 3

| | | DC Bias required | Prospective fault | Limited fault current |
|---|---|---|---|---|
| | | to reach a FCL | current with no | with FCL in circuit |
| | | impedance of 0.08 | steel core present | with steel cores |
| FCL | Details | Ohms [kAT] | rms [A] | present rms [A] |
| FIG. 20A | A single phase FCL | 108 | 1100 | 660 |
| | wherein the DC coils | | | |
| | extend about the posts | | | |
| | and AC coil | | | |
| FIG. 20B | A single phase FCL | 80 | 1100 | 466 |
| | according to an | | | |
| | embodiment of the | | | |
| | invention | | | |
| FIG. 20C | A single phase FCL | 62.6 | 1100 | 400 |
| | according to another | | | |
| | embodiment of the | | | |
| | invention with | | | |
| | substantially non- | | | |
| | uniform steel core | | | |
| | cross-sectional area | | | |

The experimental results of FIG. 23 and the summary shown in Tables 2 and 3 clearly show that the FCLs of FIGS. 20B and 20C show superior fault current limiting performance with the best fault current limiting achieved by the FCL of FIG. 20C which has a substantially non-uniform core cross-sectional area.

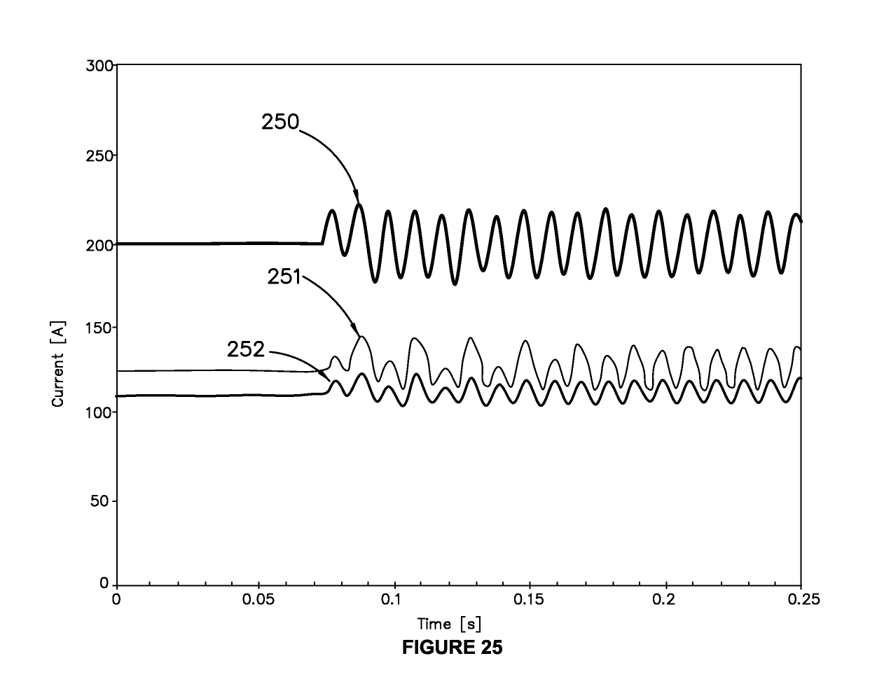

FIG. 25 shows the induced current 250, 251 and 252 into the DC bias circuit during the fault current event in each of the FCLs of FIGS. 20A, 20B, and 20C respectively, showing significantly less effects in the FCLs of FIGS. 20B and 20C. The FCL constructed with the substantially non-uniform steel core cross-sectional area, illustrated in FIG. 20C, has the lowest induced effects on the DC circuit with only approximately half the induced current compared to the FCL shown in FIG. 20B with a substantially uniform core cross-sectional area.

In some embodiments, by using the FCLs of FIGS. 20B and 20C with a 230 kV FCL, the overall footprint, or in other words the area extended onto a two dimensional plane by the structural geometry is reduced by about 55% compared to using the FCL of FIG. 20A. In another embodiment, by using the FCLs of FIGS. 20B and 20C with a 138 kV FCL, the overall footprint is reduced by about 35%. However, it will be appreciated that in other embodiments, using the FCLs of FIGS. 20B and 20C reduce the overall footprint by amounts other than 55% and 35% compared to using the FCL of FIG. 20A.

The term “footprint” as used herein, unless otherwise specified, should be understood as the underlying surface area required to accommodate a structure or device. The footprint available to accommodate an FCL is often a critical design parameter as it is common to retrofit an FCL in an existing electrical sub-station or other facility where the available surface area is limited due to the need to maintain safe physical separation of disparate pieces of equipment that are operating at high voltages. The footprint is often expressed in terms of available area on a surface. The specification can be in terms of an absolute maximum area or footprint on the surface, or an area or footprint having one or more of a maximum length and a maximum breadth on the surface. It will be appreciated that the term “footprint” can also be interpreted as meaning the area taken up by some object, or the space or area of a 2-dimensional surface enclosed within a boundary. That is, the shape of the footprint need not be regular and is, in some embodiments, defined by a complex or irregular shape.

The embodiments of the invention described above provide for a smaller footprint through the inclusion of one or a combination of features such as:
Locating the DC coils longitudinally beyond the AC coils.
Receiving the ends of the core within the DC coils and having the AC coils wound about the core intermediate the DC coils.
Locating the DC coils closely adjacent to the core.
Use of a core having a non-uniform transverse cross-section along its longitudinal length.
Enhancing the cross sectional area of one or more of the ends of the core.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

It is to be noticed that the term coupled, when used in the claims, should not be interpreted as being limited to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact or that two or more elements are not in direct contact with each other but yet still co-operate or interact with each other.

Those skilled in the art will recognise that these are examples applied to specific designs that were manufactured and that detailed results for other designs with different construction details will differ. The main conclusions and pattern of results are to be considered.

Although the invention has been described with reference to specific examples it will be appreciated by those skilled in the art that it may be embodied in many other forms.

1. A fault current limiter, comprising:
an input terminal electrically connecting to a power source that provides a load current;
an output terminal electrically connecting with a load circuit that draws the load current;
a magnetically saturable core having a longitudinally extending first portion and a second portion that extends longitudinally beyond the first portion;
an AC coil wound about the first portion for carrying the load current between the input terminal and the output terminal; and
a magnetically biasing system located closely adjacent to the second portion for magnetically biasing the core such that, in response to one or more characteristics of the load current, the AC coil moves from a low impedance state to a high impedance state.

2. The fault current limiter according to claim 1, wherein the AC coils require a predetermined physical clearance to an electrical earth and the magnetically biasing system is spaced apart from the core by less than the predetermined clearance.

3. The fault current limiter according to claim 1, wherein the magnetically biasing system includes at least one DC coil wound about and closely adjacent to the second portion.

4. The fault current limiter according to claim 3, wherein the DC coil has a notional inner surface with a first predetermined footprint and the AC coils have a notional outer surface with a second predetermined footprint that extends beyond the first footprint.

5. The fault current limiter according to claim 1, wherein the core is substantially non-uniform in cross-section.

6. The fault current limiter according to claim 1, wherein the core includes a third portion that extends longitudinally beyond the first portion.

7. The fault current limiter according to claim 6, wherein at least one DC coil is wound about and closely adjacent to the third portion.

8. The fault current limiter according to claim 3, wherein the core and the AC coil are housed within an enclosure and the at least one DC coil is outside the enclosure.

9. The fault current limiter according to claim 8, wherein the at least one DC coil is housed in a chamber.

10. The fault current limiter according to claim 8, wherein the enclosure and the DC coil include respective enclosure and DC coil footprints in a transverse plane and the DC coil footprint is no more than the enclosure footprint.

11. The fault current limiter according to claim 8, wherein the enclosure and the DC coil include respective enclosure and DC coil footprints in a transverse plane and the DC coil footprint is substantially the same as the enclosure footprint.

12. The fault current limiter according to claim 3, wherein the core, the AC coil and the at least one DC coil are housed within an enclosure.

13. The fault current limiter according to claim 7, wherein the core includes an array of longitudinally substantially coextensive posts and a plurality of AC coils respectively wound about one or more of the posts in the array, and wherein the posts in the array each have a first end and a second end and the posts are arranged such that the first ends collectively define the second portion and the second ends collectively define the third portion.

14. The fault current limiter according to claim 13, wherein the posts are substantially non-uniform in cross-section.

15. The fault current limiter according to claim 1, wherein the core is constructed from one or more of: a transformer steel lamination material; mild steel; other magnetic steel; ferrite material; an insulated high permeability compressed powder; and a ferromagnetic material.

16. The fault current limiter according to claim 8, wherein the enclosure includes a dielectric medium.

17. The fault current limiter according to claim 12 wherein the enclosure includes a dielectric medium.

18. A fault current limiter, comprising:
at least three input terminals electrically connecting to a three phase power source that provides a load current;
at least three output terminals electrically connecting with a three phase load circuit that draws the load current;
a magnetically biasing system having a central cavity;
a longitudinally extending magnetically saturable core having a plurality of posts, wherein:
each post includes a first portion and a second portion extending longitudinally oppositely away from the first portion; and
the second portion is received within the central cavity;
at least three AC coils each being wound about at least one of the first portions for carrying the load current between the input terminals and the output terminals, wherein the biasing system magnetically biases the core such that, in response to one or more characteristics of the load current, the AC coils move from a low impedance state to a high impedance state.

19. A fault current limiter, comprising:
an input terminal electrically connecting to a power source that provides a load current;
an output terminal electrically connecting with a load circuit that draws the load current;
an AC coil wound about a longitudinally extending first portion of a magnetically saturable core for carrying the load current between the input terminal and the output terminal, wherein the core and the AC coil are housed within an enclosure; and
a magnetically biasing system located adjacent the core for magnetically biasing the core such that, in response to one or more characteristics of the load current, the AC coil moves from a low impedance state to a high impedance state, and wherein the enclosure and the biasing system include respective enclosure and biasing system footprints in a transverse plane and the biasing system footprint is no more than the enclosure footprint.

20. The fault current limiter according to claim 19, wherein the magnetically biasing system includes at least one DC coil wound about the core.

21. The fault current limiter according to claim 20, wherein the core includes a second portion which extends longitudinally beyond the first portion and the DC coil is wound about the second portion.

22. The fault currently limiter according to claim 21, wherein the core includes a third portion that extends longitudinally beyond the first portion.

23. The fault current limiter according to claim 22, wherein at least one DC coil is wound about the third portion.

24. The fault current limiter according to claim 20, wherein the enclosure and DC coil footprints are substantially coextensive.

25. The fault current limiter according to claim 20, wherein the DC coil footprint lies within the enclosure footprint.

26. An enclosure for a fault current limiter, comprising:
a first port receiving an input terminal for electrically connecting to a power source that provides a load current;
a second port receiving an output terminal for electrically connecting with a load circuit that draws the load current;
a first zone receiving a first portion of a magnetically saturable core, the first zone having a predetermined first transverse footprint;
a second zone that extends longitudinally beyond the first zone for receiving a second portion of the core, the second zone having a predetermined second transverse footprint that is no more than the first footprint;
an AC coil wound about the first portion for carrying the load current between the input terminal and the output terminal; and
a magnetically biasing system located adjacent the second portion for magnetically biasing the core such that, in response to one or more characteristics of the load current, the AC coil moves from a low impedance state to a high impedance state.

27. The enclosure according to claim 26, wherein the magnetically biasing system includes at least one DC coil wound about the second portion.
